(19) United States
(12) Patent Application Publication
(10) Pub. No.: US 2015/0368116 A1
(43) Pub. Date: Dec. 24, 2015

(54) ALUMINUM OXIDE

(71) Applicant: OBSHCHESTVO S OGRANICHENNOY OTVETSTVENNOS'YU "OB'EDINENNAYA KOMPANIA RUSAL INZHENERNO-TEKHNOLOG, g. Krasnoyarsk (RU)

(72) Inventors: Aleksandr Sergeevich Senyuta, St. Petersburg (RU); Andrey Vladimirovich Panov, St. Petersburg (RU); Andrey Andreevich Smirnov, Kirovo-Chepetsk (RU)

(73) Assignee: United Company RUSAL Engineering and Technology Centre LLC, g. Krasnoyarsk (RU)

(21) Appl. No.: 14/765,701

(22) PCT Filed: Feb. 4, 2013
(86) PCT No.: PCT/RU2013/000078

§ 371 Date: Aug. 4, 2015

(51) Int. Cl. C01F 7/02; B01J 20/08

(52) U.S. Cl. CPC C01F 7/02; B01J 20/08

(57) ABSTRACT

The invention pertains to aluminum oxide, specifically, aluminum trioxide in the form of powders or agglomerations with particles having a porous honeycomb structure, and it can be used as catalyst substrates, adsorbents and filters for the chemical, food, and pharmaceutical industry. The technical result is the expanding of the types of porous aluminum oxide with honeycomb structure of pores in the micron range of sizes. The aluminum oxide, constituting separate particles with a porous structure, has porosity of the particles of 60-80%, while the porous structure is represented by extended parallel channels with close packing, the dimension of the channels at the diameter being 0.3-1.0 mcm and the length up to 50 mcm. 1 independent claim, 2 illustrations.

The invention pertains to aluminum oxide, specifically, aluminum trioxide in the form of powders or agglomerations with particles having a porous honeycomb structure, and it can be used as catalyst substrates, adsorbents and filters for the chemical, food, and pharmaceutical industry.

Aluminum oxide with a porous structure is known, being characterized in that not more than 5% of its total volume of pores is comprised of pores larger than 350 Å (“macropores”), and also by a large pore volume (more than 0.8 cm³/g, according to mercury intrusion measurements) and a bimodal nature of the pore volume distribution, i.e., a distribution of pore volumes such that when increasing pore volume is plotted as a function of pore diameter, the resulting curve has two maxima (RU patent No. 2281161, BO1J21/04, published 10 Dec. 2004).

Among the drawbacks of the given aluminum oxide is the small pore diameter, which limits its use as a catalyst substrate, adsorbent and filler of filters, especially in processes of catalyst synthesis and as a drying agent for gases containing droplet moisture.

The closest to the proposed invention is a macro-mesoporous aluminum oxide in the form of separate particles, in which the honeycomb structure of the pores is due to the use of yeast as a bio-template. The porous structure of this aluminum oxide is characterized by a chaotic arrangement of macropores with sizes of 1.5 to 3 mcm in the form of a labyrinth, whose walls contain interconnected pores with dimensions of 3 to 4.5 nm (Yuan Ma, Qinglian Wei, Ruowen Ling, Fengkai An, Guangyu Mu, Yongmin Huang. Synthesis of macro-mesoporous alumina with yeast cell as bio-template. Microporous and Mesoporous Materials. Elsevier, 165 (2013), p. 177-184, 2012).

The drawback of this aluminum oxide is the chaotic labyrinthine arrangement of the macropores, which increases the hydraulic resistance, and this impedes the passage of substances participating in various processes inside the particles and access to the internal surface of the aluminum oxide, where both catalytic reactions and adsorption can take place.

Moreover, one can also consider as drawbacks the complexity and lengthiness of the process for production of such an aluminum oxide.

The problem which the invention seeks to solve is the expanding of the types of porous aluminum oxide with honeycomb structure of pores in the micron range of sizes. The technical result is an achievement of this goal.

The accomplishment of the above mentioned technical result is achieved in that the porosity of the particles in aluminum oxide constituting separate particles with a porous structure amounts to 60-80%, while the porous structure is represented by extended parallel channels with close packing, the dimension of the channels at the diameter being 0.3-1.0 mcm and the length up to 50 mcm.

When such an aluminum oxide is used, it is easier for the substances participating in various processes to pass into the particles, affording them access to the internal surface of the aluminum oxide, where both catalytic reactions and adsorption can take place.

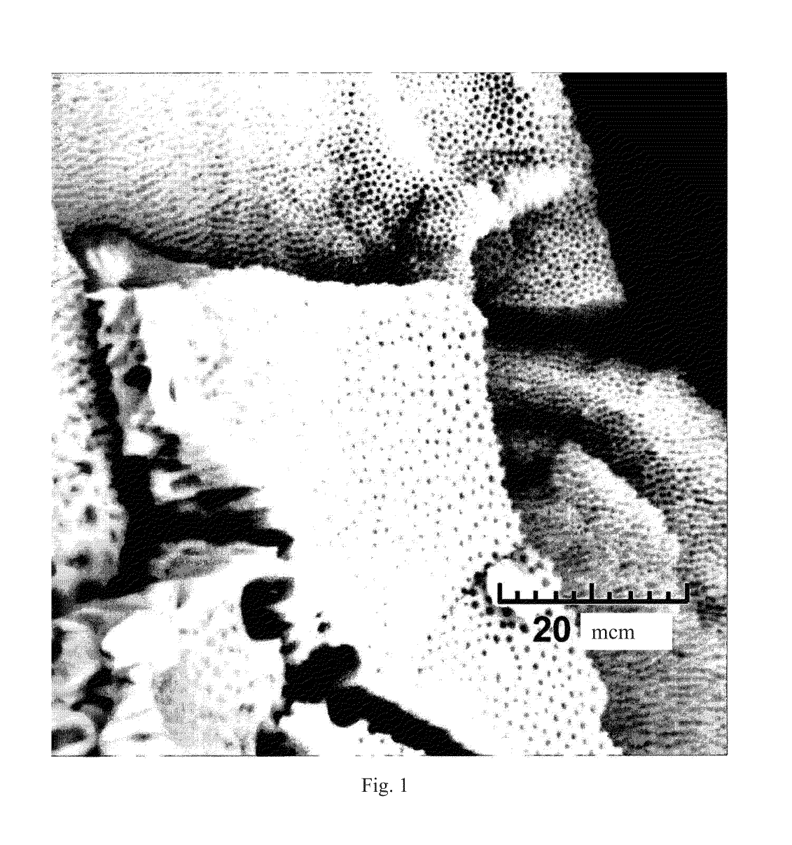

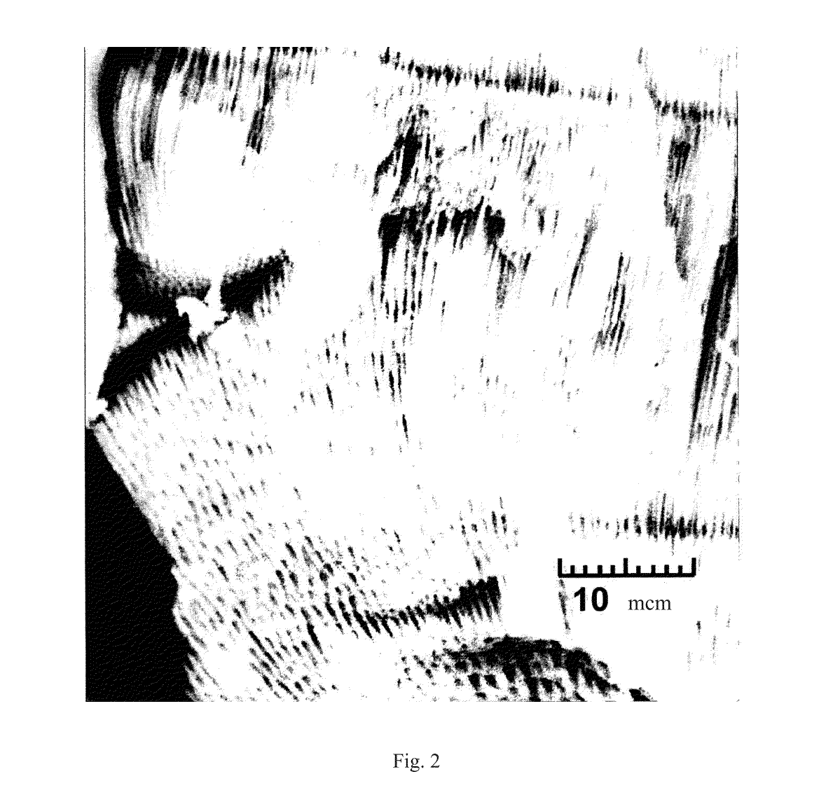

The essence of the invention is explained by the graphic materials. FIG. 1 shows the outer surface of a particle of aluminum oxide with pore openings emerging onto the outside, demonstrating their close packing. FIG. 2 shows a cleavage of a particle of aluminum oxide, revealing the extent of the parallel channels.

The aluminum oxide is produced as follows.

Crystals of aluminum chloride hexahydrate are processed with excess aqueous solution of ammonia (content of NH₃-25 wt. %) at a temperature of 20-80° C., which increases in the course of the reaction due to the exothermal effect of the reaction. The particles processed with the aqueous solution of ammonia visually preserve their external shape and dimensions of the original crystals of aluminum chloride hexahydrate, yet they are constituted (according to X-ray phase analysis) of aluminum hydroxide in the polymorphous modification boehmite (AlOOH). The boehmite particles are washed with water until the medium is neutral, dried at 105° C. to constant weight, and roasted at a temperature of 650-750° C. for one hour.

The aluminum oxide so obtained has a gamma polymorphous modification and contains, wt. %: Al_{2A}O₃ 98.6; Na₂O 0.005; Fe₂O₃ 0.01; SiO₂ 0.01; Cl⁻<0.01.

The particles of the resulting aluminum oxide are pierced by extended parallel channels (pores) whose openings emerge onto the outer surface. The dimensions of the channels are diameter of 0.3-1.0 mcm and length up to 50 mcm. The porosity of the particles, determined mathematically on the basis of measurement of macroscopic photographs, is 60-80%.

When such aluminum oxide is used, the passage of the substances participating in various processes into the inside is facilitated, which affords access to the internal surface of the aluminum oxide, where both catalytic reactions and adsorption can take place.

There is no reprecipitation of the hydrated aluminum compounds during the production of this aluminum oxide. Thus, the dimension of the resulting particles and, consequently, the lengths of the pores are determined solely by the initial size of the crystals of the initial substance—aluminum chloride hexahydrate.

The hygroscopicity of the aluminum oxide, determined experimentally, was 0.62 cm³/g. Thus, this substance has a high capacity to absorb droplet moisture.

1. Aluminum oxide, in the form of separate particles having a porous structure, characterized in that the porosity of the particles amounts to 60-80%, while the porous structure is represented by extended parallel channels with close packing, the dimension of the channels at the diameter being 0.3-1.0 mcm and the length up to 50 mcm.
